(19) United States
(12) Patent Application Publication
(10) Pub. No.: US 2019/0014768 A1
(43) Pub. Date: Jan. 17, 2019

(54) APPARATUS FOR DISPENSING AROMATIC SOLUTIONS

(71) Applicant: Jerry W. Noles, Blanchard, OK (US)

(72) Inventor: Jerry W. Noles, Blanchard, OK (US)

(21) Appl. No.: 16/033,840

(22) Filed: Jul. 12, 2018

Related U.S. Application Data
(60) Provisional application No. 62/531,644, filed on Jul. 12, 2017.

(51) Int. Cl. A01M 1/20; G06F 9/451

(52) U.S. Cl. CPC A01M 1/2038; B05B 12/004; A01M 2200/012; G06F 9/451

(57) ABSTRACT

An apparatus for dispensing an aromatic solution includes a casing with an orifice, a programmable remote, a cartridge filled with an aromatic solution, and a battery.

### CROSS-REFERENCE TO RELATED APPLICATIONS

This application claims the benefit of and priority to U.S. Provisional Patent Application No. 62/531,644 title “Mosquito Guardian” and filed Jul. 12, 2017, the disclosure of which is incorporated in its entirety by this reference for all purposes.

### TECHNICAL FIELD

The disclosed subject matter relates to systems and methods for repelling insects, such as mosquitoes and other biting insects.

### BACKGROUND

Within the last few years, the world has seen an increase in diseases from blood borne pathogens. Many of these diseases are spread through insects such as mosquitoes, ticks, flies, arthropods (e.g., spiders), and the like that transfer the disease from one host to another. Some of the diseases that are best known include malaria and the Zika virus.

These viruses have made the general population aware of the need to control and protect against mosquitoes and other vectors such as ticks, flies, and the like. The problem is that many repellents can generate allergic reactions. In some instances, long term exposure to chemicals like diethyltoluamide, or DEET, found in many repellents may harmful to the user.

For this reason, some people prefer to control insects, such as mosquitoes, by eliminating breeding grounds or by treating the areas in which mosquitoes are most likely to breed.

Additionally and/or alternatively, some people may elect aromatic repellents, such as natural oils, perfumes, and essences, like citronella oil. These aromatics have proven effective in protecting and controlling small areas but may not be as effective in large or open areas or when conditions are windy. Further, if the aromatic perfume is incorporated into a paraffin or wax, such as that used in a candle, there may be smoke and/or an open flame or other source of heat/power to warm the paraffin or wax. However, smoke and open flames may be hazardous in confined areas, windy conditions, dry conditions, or more. If another source of heat/warmth is provided, such as with an electrical resistive element, a source of power (battery or direct current, or alternating current if plugged into an electrical outlet and thereby connected directly to the electrical grid) is necessary, further limiting the convenience and areas in which the aromatic device may be used.

It is for these reasons and more that some companies have developed misting systems that use essential oils such as agar, ajwain, anise, basil, bay, bergamot, cajeput, calamodin, caraway, carrot seed, cedar, citrus, clove, eucalyptus, geranium, lavender, lemon, lemon eucalyptus, lemon grass, litsea cubeba, melissa, mint, neroli, perilla, peppermint, pine, rosemary, sassafras, savory, spearmint, tea tree, thyme, tsuga, vetiver and wintergreen to name a few.

Although these oils have proven effective at preventing insects, such as mosquitoes, from approaching the area of application, the systems that apply these oils are elaborate and expensive. For instance, professional installation and continuous maintenance are typically involved.

Therefore, there is a need for a simple, inexpensive system to repel insects that does not require professional installation and frequent maintenance.

### BRIEF SUMMARY

In an embodiment, a system includes a self-contained design for the dispersion of small volumes of aromatic repellents to protect household areas such as back porches or patios. In embodiments, the design is very inexpensive. These aromatics can include any repellent that can be readily solubilized and incorporated into the spray applicator. In embodiments, the system uses an application method that may be used for the application of deodorants in many commercial restrooms. These systems may use small aerosol spray cans filled with deodorant to provide the atomization of the deodorant when the unit is activated. Essential oils or other aromatic repellents may be used. These units optionally use batteries to provide power for a timer that can be set to administer small dosages of the aerosol material. They can be operated manually or set to operate at periodic intervals depending on the user requirement. These units can also be manually operated by a push activation of the aerosol. These units are small and can be secured to a wall or eve through the use of fasteners, such as screws, bolts, nails, glue, or adhesive or double-sided tape. They can be strategically placed around the perimeter of areas to repel and prevent mosquitoes or other insects from entering into certain areas.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 illustrates a casing containing an orifice through which the aromatic repellent is released.

FIG. 2 illustrates a programmable remote, a cartridge bay, and a bay for the battery all of which are disposed inside the casing of FIG. 1.

FIG. 3 illustrates the programmable remote disposed inside the casing of FIG. 1.

The drawings are not necessarily to scale.

### DETAILED DESCRIPTION

Embodiments of the present disclosure will now be further described. In the following passages, different aspects of the disclosure are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

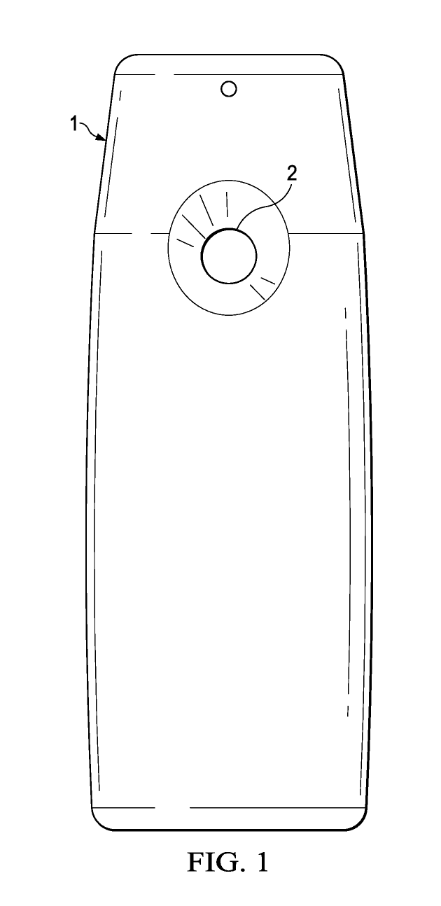

FIG. 1 illustrates a casing 1 containing an orifice 2 through which an aromatic solution is released. The casing 1 may be wrapped with a coating, dipped, and/or sprayed to resemble the environment in which the unit is disposed.

The orifice 2 may be any size that allows the mist and/or spray of the aromatic solution to clear the casing 1. The aromatic solution may comprise essential oils. The orifice optionally includes at least one nozzle and, in some embodiments, a plurality of nozzles. The nozzle or nozzles may dispense the solution in a pattern. The plurality of nozzles may be separately selectable and configured to dispense the aromatic solution in a pattern that is different from the pattern of each of the other of the plurality of nozzles. The nozzle and, consequently, the pattern may be manually selectable. Optionally, the nozzle may be operatively coupled to a control system 3. For example, an actuation mechanism may be operatively coupled to the nozzle or the plurality of nozzles and to the control system. The control system may transmit an actuation signal to the actuation mechanism coupled to nozzle or to the plurality of nozzles. The control system may further perform functions comprising adjusting or selecting a nozzle in accordance with computer executable instructions stored in a computer memory connected to the processor.

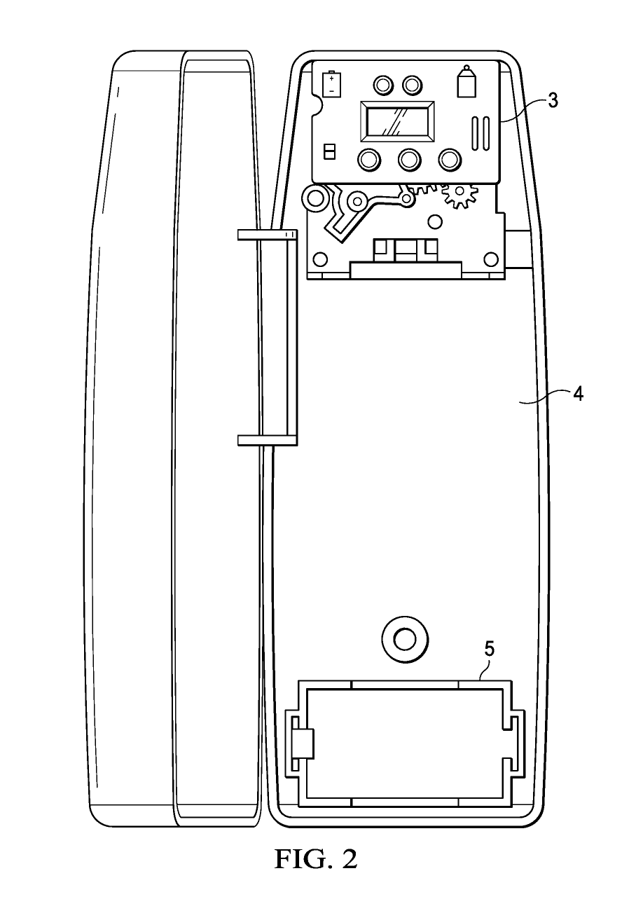

FIG. 2 illustrates the control system 3, such as a programmable remote, a cartridge bay 4, and a battery bay 5 containing a battery (not pictured) all of which are disposed in casing 1.

The control system 3 includes a processor configured to implement computer executable instructions. An input interface, such as a remote control, touch pad, dial, keypad or keyboard, a remote computer or handheld personal digital assistant or smart phone connected via ethernet cable to the Internet, Wi-Fi, cell, Bluetooth™, near field communication, or other such device, is in communication with the processor. The input interface is configured to receive an indication of a desired action from a user.

The control system 3 also includes an output interface, such as a digital displace, screen, or the remote computer or handheld personal digital assistant or smart phone connected via ethernet cable to the Internet, Wi-Fi, cell, Bluetooth™, near field communication, or other such device, is in communication with the processor and configured to output an indication of the desired action. In the is way, the user can confirm his or her desired action. The desired action may be a single instruction or it may be a plurality of instructions, to be stored in a computer memory and run or executed via the computer program or computable executable instructions.

The control system also optionally includes at least one sensor configured to receive an indication of a selected parameter, the at least one sensor being operatively coupled to the processor. The at least one sensor is selected from the group consisting of a pressure sensor, a temperature sensor, a photo-electric eye, a wind speed sensor, a humidity sensor, an imaging sensor, and a motion detecting sensor. The at least one sensor may include a plurality of sensors.

The control system of claim 16 also optionally includes a timer operatively coupled to the processor and configured to send a time signal indicative of a time to the processor.

The control system 3 includes a computer memory in communication with the processor and storing data representing a computer program or computer executable instructions, that when implemented by the processor cause the processor to perform functions comprising at least one of: dispensing the aromatic solution in accordance with the computer executable instructions; receiving the indication of the desired action; modifying the computer executable instructions in accordance with the received indication of the desired action; outputting the indication of the desired action to the output interface; transmitting an actuation signal to a first actuation mechanism, such as the actuation mechanism coupled to the cartridge and/or the actuation mechanism coupled to the nozzle or nozzles; receiving the indication of the selected parameter; dispensing the aromatic solution as a function of the selected parameter in accordance with the computer executable instructions; receiving the time signal; and, dispensing the aromatic solution as a function of the time signal in accordance with the computer executable instructions.

The cartridge bay 4 optionally houses a cartridge (not pictured) that is filled with an aromatic solution, although in other embodiments the aromatic solution may simply be received within a reservoir in the casing 1.

In a non-limiting example, the cartridge may be a pressurized aerosol container, i.e., the pressure of the aromatic solution held within the cartridge is at a higher pressure than an ambient pressure in the location in which the system is positioned or located. The cartridge is fluidly coupled, such as with tubing, piping, and or other passageways, to the orifice. An actuation mechanism, such as a valve may be disposed between the cartridge and the orifice. The actuation mechanism is electrically connected to the power source and receives an operating signal from the programmable remote, which operates the actuation mechanism or valve in accordance with a computer program controlling the time and duration of operation and other such parameters. The aromatic solution remains in the cartridge until it is released automatically into the environment in accordance with a program, when a specified condition occurs or a selected parameter is realized, at a specified time, and/or when the user releases the aerosol solution manually at the unit.

While the term cartridge may refer to a pressurized aerosol container, it also can refer to another receptacle, such as plastic bag or other enclosed container that is fluidly coupled to an actuation mechanism, such as a pump. The pump is electrically connected to the power source and receives an operating signal from the programmable remote, which operates the pump in accordance with a computer program controlling the time and duration of operation and other such parameters.

The system may be provided with a power source, such as an electrical plug to be connected to an electrical outlet and thereby to the electrical grid, hardwiring for a direct electrical connection to a source of electrical power, or with a battery, either as the sole source of power or as a backup to another electrical source of power, such as a solar panel. In those embodiments with a battery, the battery may be rechargeable and/or disposable.

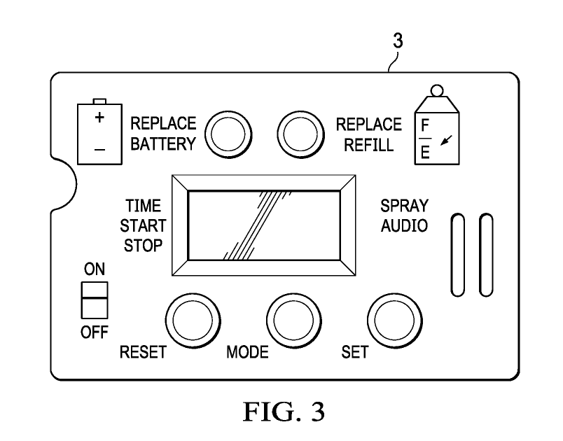

FIG. 3 illustrates programmable remote 3. The programmable remote 3 may control a variety of parameters some of which include, but are not limited to, the amount of aromatic solution released, when the aromatic solution is released, the pattern in which the aromatic solution is released, when the unit is powered on, when the unit is shut down and the like. In addition, the programmable remote 3 may control the release the aerosol as a function of one or more parameters, including: a) an interval or intervals of time in which to activate the system; b) the prevailing weather conditions (humidity, wind, temperature, time of day (greater frequency in the evening, for example)); c) the concentration or frequency of spraying the aerosol/oil as a function of the type of aerosol/oil; d) the location of the system (indoor/outdoor); e) the volume of the area in which an effective dose of aerosol is to be dispensed into (less volume dispensed for smaller volumes, greater volume dispensed for large volumes, such as open areas); and more.

The programmable remote 3 may be linked and controlled by any device (not illustrated) with internet access, such as but not limited to, a mobile device, a tablet, a traditional computer, and/or any combination thereof. The programmable remote 3 may also be controlled directly at the unit.

In one embodiment, the unit is strategically positioned at an elevated area and an aromatic solution containing an essential oil is put into a pressurized aerosol container wherein a timer (whether battery operated or otherwise connected to the power source) connected to the control system is used to administer small dosages of a nontoxic essential oil to repel insects such as, but not limited to, spiders, ticks and mosquitoes. The essential oil used may be, but is not limited to, lavender, basil, pine, vetiver, peppermint, tea tree, eucalyptus, lemon eucalyptus, clove, lemon grass, cedar, geranium, citrus, lemon, and/or any combination thereof. The aromatic solution comprising essential oil generates an airborne vapor that can travel great distances to protect large areas during the time that the area is occupied. This unit can be turned on and off when not in use and set to dose at a specified frequency. This unit may also be linked to a device with internet access. The device may be used to control a number of factors such as, but not limited to, when the device is powered on and off, when the aromatic solution is released, how the aromatic solution is released, the pattern in which the aromatic solution is released, and the like.

In another embodiment, the essential oils used in the aromatic solution may be of a sufficient density and a mist pattern as to cover a spray pattern on the ground to prevent spiders and tics from entering the area. Essential oils that may be used include, but are not limited to, lavender, peppermint, tea tree, eucalyptus, citronella, clove, lemongrass, geranium, citrus, cinnamon, rose, lemon, and/or any combination thereof. These units may be strategically positioned around an infrastructure such as a house or building to prevent insects from entering into it. The timer on the units can be set to operate on a daily basis and may function for months without service. The unit may be linked to a device with internet access, where the timer among other functions can be set off site.

In another embodiment, the units can be positioned so that the aromatic solution may be deployed to repel pests such as dogs, squirrels, birds, and insects from flower beds or gardens. Essential oils that may be used in the aromatic solution include, but are not limited to, citrus, cinnamon, eucalyptus, sour apple, garlic, red pepper, lemon grass, thyme, clove, peppermint, and or any combination thereof. The units may be disposed on a pole, on the ground, on a tree or plant, or on some type of infrastructure. The unit may be filled with an aromatic solution that may be released at specified time intervals.

In another embodiment, the units may be camouflaged and attached by clamp or cordage to a tree or an infrastructure such as, but not limited to a deer stand, and used to deploy aromatic solution such as, but not limited to, pheromones or buck scent for the attraction of wildlife such as deer or other scent attracted animals. The deployed aromatic solution may also mask the scent of the pheromones and carbon dioxide put off by the hunter and therefore may act as a distractor.

In another embodiment, the units are mounted on poles and strategically positioned to generate a barrier to repel insects for a desired area. The units may be set by a timer to automatically release the aromatic solution or the aromatic solution may be released manually at the unit. The units may be painted, wrapped or coated to resemble their intended surroundings.

In another embodiment, the units are mounted on poles, and the poles are driven into the ground. The poles are positioned around the perimeter of a garden or flower bed and are filled with an aromatic solution that acts as an animal repellent. The unit may be set up to release the repellent at specified time intervals and/or when a motion detector has sensed an animal in the designated area. The motion detector will set off the unit and release the aromatic solution once an animal is detected.

In yet another embodiment, the units are tied to a motion detector and are used to deploy an aromatic solution that acts as an animal repellent and are positioned to generate a barrier. The barrier thereby prevents animals from digging up flower beds or coming into an area that is deemed as protected by the repellent. Once an animal sets off the motion detector, a signal is sent to the unit, and the unit then releases the aromatic repellent.

In another embodiment, the units may be connected to and powered by a solar panel thereby eliminating the need to charge or change out batteries. The solar panel may be directly connected to the unit.

In another embodiment, the units may be connected to and powered directly from any power source thereby eliminating the need to charge or change out batteries. Any suitable power source may be used such as, without limitation, battery power, solar power, electricity, and the like.

In yet another embodiment the units are positioned in a barn or stall to repel and prevent fly infestations. The units may be attached to the barn or stall in any suitable manner. The units may be programmed to release the aromatic solution that acts as a repellent at specified time intervals or may be released manually at the unit. The aromatic solution comprises essential oils that may include, but are not limited to, lavender, basil, thyme, pine, vetiver, bergamot, peppermint, and/or any combination thereof.

In another embodiment, multiple units are positioned on opposite sides of a corridor and tied to a motion detector on a livestock operation, such as but not limited to a dairy or cattle operation. As the animals pass between the motion sensors, the units are set off and a mist of pesticide or aromatic solution is delivered to the livestock to repel flies and other pests. The sensor may be a motion sensor and/or an electronic eye. The units could also be triggered to release the aromatic solution based on a pressure plate and/or load cell. The sensors may also be positioned above the animals to allow the mist to drift and settle onto the animals' backs.

In another embodiment, the units may be wrapped with a coating, dipped, and/or sprayed to blend in with the back drop or even be camouflaged to prevent detection.

It should be understood that in any embodiment “units” and “unit” are interchangeable and non-limiting.

The one or more present inventions, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A system for dispensing an aromatic solution comprising:
a casing, wherein the casing includes an orifice;
a control system operatively coupled to a first actuation mechanism;
a cartridge fluidly coupled to the orifice, wherein the cartridge is filled with an aromatic solution; and
a power source.

2. The system of claim 1, wherein the first actuation mechanism is one of a pump and a valve.

3. The system of claim 1, wherein the aromatic solution is held in the cartridge at a pressure that is higher than an ambient pressure where the system is positioned.

4. The system of claim 1, wherein the power source is an electrical source.

5. The system of claim 4, wherein the electrical source is from at least one of an electrical grid, a solar panel, and a battery.

6. The system of claim 5, wherein the batter is at least one of replaceable and rechargeable.

7. The system of claim 1, wherein the control system comprises:
a processor configured to implement computer executable instructions;
a first input interface in communication with the processor and configured to receive an indication of a desired action;
a first output interface in communication with the processor and configured to output an indication of the desired action; and,
a computer memory in communication with the processor and storing data representing computer executable instructions, that when implemented by the processor cause the processor to perform functions comprising:
dispensing the aromatic solution in accordance with the computer executable instructions.

8. The system of claim 1, further comprising at least one sensor configured to receive an indication of a selected parameter, the at least one sensor being operatively coupled to the control system.

9. The system of claim 8, wherein the at least one sensor is selected from the group consisting of a pressure sensor, a temperature sensor, a photo-electric eye, a wind speed sensor, a humidity sensor, an imaging sensor, and a motion detecting sensor.

10. The system of claim 1, wherein the orifice includes at least one nozzle configured to dispense the aromatic solution in a pattern.

11. The system of claim 11, wherein the at least one nozzle includes a plurality of nozzles, wherein each of the plurality of nozzles is separately selectable and configured to dispense the aromatic solution in a pattern that is different from the pattern of each of the other of the plurality of nozzles.

12. The system of claim 10, wherein the pattern is manually selectable.

13. The system of claim 10, wherein the nozzle is operatively coupled to the control system.

14. The system of claim 11, wherein a second actuation mechanism is operatively coupled to the plurality of nozzles and the control system.

15. The system of claim 1, further comprising a timer operatively coupled to the control system and configured to send a time signal indicated of a time to the control system.

16. A control system for an apparatus that dispenses an aromatic solution, the control system comprising:
a processor configured to implement computer executable instructions;
an input interface in communication with the processor and configured to receive an indication of a desired action;
an output interface in communication with the processor and configured to output an indication of the desired action; and,
a computer memory in communication with the processor and storing data representing computer executable instructions, that when implemented by the processor cause the processor to perform functions comprising:
dispensing the aromatic solution in accordance with the computer executable instructions.

17. The control system of claim 16, wherein the processor further performs functions comprising:
receiving the indication of the desired action;
modifying the computer executable instructions in accordance with the received indication of the desired action;
outputting the indication of the desired action to the output interface.

18. The control system of claim 16, wherein the processor further performs functions comprising transmitting an actuation signal to a first actuation mechanism.

19. The control system of claim 16, further comprising at least one sensor configured to receive an indication of a selected parameter, the at least one sensor being operatively coupled to the processor, wherein the processor further performs functions comprising:
receiving the indication of the selected parameter;
dispensing the aromatic solution as a function of the selected parameter in accordance with the computer executable instructions.

20. The control system of claim 16, further comprising a timer operatively coupled to the processor and configured to send a time signal indicative of a time to the processor, wherein the processor further performs functions comprising:
receiving the time signal;
dispensing the aromatic solution as a function of the time signal in accordance with the computer executable instructions.
